(19) United States
(12) Patent Application Publication
(10) Pub. No.: US 2016/0225467 A1
(43) Pub. Date: Aug. 4, 2016

(54) ENERGY GENERATING APPARATUS AND ENERGY GENERATING METHOD AND CONTROL AS-SEMBLY AND REACTION VESSEL THEREFORE

(71) Applicants: AIRBUS DEFENCE AND SPACE GMBH, Ottobrunn (DE); AIRBUS OPERATIONS GMBH, Hamburg (DE); AIRBUS DS GMBH, Taufkirchen (DE)

(72) Inventors: Bernhard Kotzias, Bremen (DE); Ralf Schliwa, Dollern (DE); Jan van Toor, München (DE)

(21) Appl. No.: 15/022,405

(22) PCT Filed: Sep. 17, 2014
(86) PCT No.: PCT/EP2014/069828

§ 371 Date: Mar. 16, 2016

(30) Foreign Application Priority Data
Sep. 17, 2013 (DE) 10 2013 110 249.2

(51) Int. Cl. G21B 3/00; G21D 3/14; G21D 7/04

(52) U.S. Cl. CPC G21B 3/006; G21D 7/04; G21D 3/14; G21B 3/008

(57) ABSTRACT

An environmentally friendly heat energy source suitable for the transportation sector, includes an energy generating apparatus for generating heat energy in an exothermic reaction in the form of a metal lattice supported hydrogen process, advantageously an LENR, comprising: a reaction vessel with a reaction chamber containing a reaction material for performing the exothermic reaction, a field generating device for generating a field in the reaction chamber for activating and/or maintaining the exothermic reaction, a heat transfer device for transferring heat into and/or out of the reaction chamber, and a control which controls the field generating device depending on the reaction chamber temperature, for stabilizing or controlling the exothermic reaction. The control connects to a thermoelectric generator for converting heat from the reaction chamber into electrical energy such that enough energy for generating the field is only available when the temperature is above a critical range, for instance above 500 K.

The invention relates to an energy generating apparatus and an energy generating method for the generation of energy. Furthermore, the invention relates to a control assembly and a reaction vessel for such an energy generating apparatus.

The invention relates especially to an energy generating apparatus with a reaction vessel or a cell for producing heat energy in an exothermic reaction. As an exothermic reaction especially a quantum condensate on a metal lattice supported electrodynamic process with hydrogen is carried out. The participation of weak and strong interaction is not excluded. Advantageously, an LENR is carried out as the exothermic reaction, LENR standing for “low energy nuclear reaction” This name has a historical basis, in the end low energy reaction product are produced by a fusion of nucleons.

Latest research results show that hydrogen, this includes all isotopes of hydrogen including light hydrogen, deuterium and tritium, with the assistance of metal lattices under the action of impacts and resonance effects may be used for the generation of energy.

Reaction materials for carrying out such metal lattice assisted electrodynamic condensation processes, as for instance LENR materials, are already known and are realized by a number of companies, especially the Leonardo Corporation see also WO 2009/125444 A1 or the companies Defkalion Green Technology, Brillouin Energy or Bolotov. Others, as for example explained in the below mentioned citations [8], [9], [10], implement compositions of transition metals and semimetals.

The term LENR+ means LENR processes which proceed making use of nanopartides specifically designed for these processes.

Under http://www.heise.de/tp/artike1/36/36635/1html: Kalte Fusion als Game Changer, Haiko Lietz, 23.03.2012, Teil 11, topics of public debate about LENR are put together.

JP 2004-85519A discloses a method and an apparatus for generating large energy amounts and helium by means of nuclear fusion making use of high density deuterium in nanoparticles.

WO 95/15563 discloses a method and an apparatus for generating neutrons from solid state materials which conduct protons. A high neutron radiation is envisaged. The know apparatus has a system for temperature control.

WO 91/02360 as well proposes a method and an apparatus where in addition to heat radiation shall be produced in an electrochemical nuclear process.

US 2012/0008728 A1 proposes the use of a resonance-high-frequency-high-voltage-source for the efficient energy supply of a fusion tube which contains D, T or He3 vapor.

US 2011/0122984 A1 describes a practical technique for inducing and controlling a fusion of nuclei in a solid state material lattice. A control for starting and stopping a phonon energy stimulation and loading the lattice with light nuclei is proposed, in order to allow for the distribution of energy which is released by the fusion reactions before it reaches a point at which the reaction lattice will be destroyed.

From WO 2010/096080 A1 a nuclear energy source is known which comprises an active layer of Pd grains, a power supply, a thermoelectric converter and a heat collector.

WO 01129844A1 describes a method and an apparatus for generating thermal energy using nuclear hydrogen processes in a metal lattice. A control is disclosed which supplies energy for generating fields for stabilizing the processes. The control controls the processes as a function of the temperature, in order to keep the temperature in a reactor constant. Furthermore, a thermoelectric generator is disclosed which converts heat energy from the reaction chamber into electrical energy and stores the electrical energy in an electrical energy accumulator, for instance in a buffer battery. The control is supplied by the generator and the electrical energy accumulator. The control is connected to output connectors of the electrical energy accumulator for initiating and controlling the nuclear reaction. The control serves for regulating the produced thermal energy by controlling the strength or the frequency of stimulated current pulses in order to avoid a too high temperature which would lead to the destruction of the apparatus by melting.

For the explanation of the invention and its advantageous embodiments reference is especially made to the following citations:
[1] WO 2013/076378 A2,
[2] N. Pazos-Perez et al.: Organized Plasmonic Cluster with High Coordination Number and Extraordinary Enhancement in Surface-Enhance Raman Scattering (SERS), Wiley, Angewandte Chemie, Int. Ed. 2012, 51, 12688-12693,
[3] Maria Eugenia Toimil Molares: Characterization and properties of micro- and nanowires of controlled size, composition, and geometry fabricated by electrode-position and ion-track technology, Beilstein Journal of Nanotechnology, 2012, 3, 860-883, published 17 Dec. 2012,
[4] U.S. Pat. No. 8,227,020 B1,
[5] F. Olofson, L. Holmlid: Detection of MeV particles from ultra-dense protium p(−1): Laser-initiated self-compression from p(1); nuclear Instruments and Methods in Physics Research B 278 (2012) 34-41,
[6] Nuclear processes in solids: basic 2nd order processes. P. Kalman, T. Keszthelyi, University of Technology and Economics, Budapest,
[7] Resonance like processes in solid 3rd and 4th order processes, P. Kalman, T. Keszthelyi, University of Technology and Economics, Budapest,
[8] Program on Technology Innovation: Assessment of Novel Energy Production Mechanisms in a Nanoscale Metal Lattice, Principle Investigator B. Ahern, Electric Power Research Institute Report 2012, USA,
[9] Cold Fusion Nuclear Reactions, Horace Heffner, 2009,
[10] Life at the center of the energy crisis, G. H. Miley, Word Scientific, 2013.

Preferred embodiments of the invention aim at the creation of an autonomous this means especially portable, compact generator for energy supply, which may be used for various applications. Applications in the automobile construction and the vehicle construction, in the aircraft industry, the shipping industry and for aerospace are intended.

Various heat energy sources for such fields are already in use since long. Conventional cells for the energy supply are for example driving machines, as for example turbines or piston machines, which are based on chemical combustion or oxidation processes making use of fossil or synthetic fuels. There is a high demand for replacing currently used heat energy sources as they have a number of disadvantages.

In particular, a heat source replacing known heat energy generators for the transportation sector, e.g. in automobile manufacturing, shipbuilding, for space missions, but also for research and test purposes and expeditions and for field applications or military applications with mobile units shall be provided with the present invention.

Heat sources avoiding the use of fossil fuels are already in use for space missions or submarines, these, however, employ a conventional technology known for a long time, that is in particular the nuclear radioactive heat sources, for instance resting upon uranium fission or simply using the plutonium decay.

A new technology which provides the advantageous features of the conventional technology with regard to reliability and autonomous operation, however in combination with a waste-free operation and an operation devoid of radioactive radiation, this in addition at competitive costs, will provide a particularly high potential for industrial applications, especially in the transportation sector.

Existing cells making use of exothermic reactions have the disadvantage that they are not autarchic and not self-sustaining, respectively, whereby the risk of exothermal instabilities requires a control and an external supply for the operation.

An exothermic energy source for the transportation sector, such as automobile manufacturing, aeronautics and aerospace, should meet the following criteria:
1. The energy source should be environmentally friendly and sustainable, that is, contrary to the conventional carbon-based energy generation, it should generate energy without the generation of greenhouse gases, and furthermore without radiation and without waste, especially without radioactive waste. It should also work carbon-free in view of secondary energy sources, as for example energy sources or fuels which are generated by wind energy or solar energy.
2. As regard the power the energy source should be able to be designed within the range from a few watts to megawatts as the nominal power.
3. The energy source should be integrable into small units, as for examples into automobiles or aircrafts and space crafts.
4. It should be lightweight as regards the work to be performed. A value smaller than 10 MWh/kg would be desirable.
5. It should be lightweight as regards the power which is made available. A value smaller than 1 kW/kg would be desirable.
6. It should work continuously over an extended period of time without a need for recharging or refueling. An operating time of more than 1 month without recharging or refueling would be desirable.
7. It should be autarchic and self-sustaining, respectively, that is it should ensure an operation without the need of adding external energy or power.
8. It should work reliably to a significant extent.
9. It would be desirable that a cell once constructed works without recharging or refueling and that it is recyclable after its lifetime in the sense of a sustainable management.

The currently closest solution which fulfills most of the above listed points is the so-called “RTG” (abbreviation for radioactive thermo generator) which use plutonium as fuel material or energy source. However, such a solution of radioactive thermal generators should not be taken into consideration as it does not fulfill the important point 1.

Thus, the invention proposes an improved metal lattice supported electro dynamical condensation process using hydrogen, in particular improvements compared with the lattice supported collective hydrogen process (LENR or LANR), wherein the term “hydrogen” may be understood both as light or heavy hydrogen.

Lattice supported reactions are already known. In particular, LENR (low energy nuclear reaction) has to be mentioned as an example. When carried out correctly, this kind of reaction produces neither radioactive waste nor dangerous radiation and may fulfill the points 1 and 4 to 6 as regards the energy cell or energy source. The objectives 2 to 6 may be achieved with appropriate designs based on the common knowledge of an engineer using the inherent capabilities of an LENR system.

It is the object of the present invention to create an apparatus and a method for generating of energy with which as many criteria as possible of the above mentioned criteria 1 to 9 may be achieved.

For this, according to the present invention an energy generating apparatus with the features of claim 1 and an energy generating method with the steps of the further independent claim are proposed. Furthermore, a control assembly and a reaction vessel for such an energy generating apparatus and for supporting such an energy generating method, respectively, are proposed.

Advantageous embodiments are the object of the dependent claims.

According to one aspect the invention provides an energy generating apparatus for generating heat energy in an exothermic reaction in the form of a metal lattice supported hydrogen process comprising:

a reaction vessel with a reaction chamber containing a reaction material for carrying out the exothermic reaction,
a field generating device for generating a field in the reaction chamber for activating and/or maintaining the exothermic reaction,
a heat transfer device for transferring heat into and/or out of the reaction chamber, and
a control which is designed to control the field generating device depending on the temperature in the reaction chamber for stabilizing the exothermic reaction, characterized in that for the sole energy supply of the control a thermoelectric generator, which is designed to convert heat energy from the reaction chamber into electrical energy, is connected with the control, in order to operate the control by means of the heat of the reaction chamber such that the control is only supplied with sufficient energy, when the temperature in the reaction chamber is above a predetermined critical temperature, in order to control the field generating device for generating the field which generates or maintains the reaction.

According to a further aspect the invention provides a control assembly for such an energy generating apparatus, wherein the control assembly comprises: a field generating device for generating a field in a reaction chamber for activating and/or maintaining the exothermic reaction, and a control which is designed to control the field generating device depending on a temperature in the reaction chamber for stabilizing the exothermic reaction, wherein for the sole energy supply of the control a thermoelectric generator which is designed to convert heat energy from the reaction chamber into electrical energy, is connected with the control, in order to operate the control by means of the heat of the reaction chamber, such that only in the case of an operating temperature above a predetermined critical temperature the control is provided with sufficient energy, in order to control the field generating device for generating the field which produces or maintains the reaction.

According to a further aspect the invention provides a reaction vessel for such an energy generating apparatus for generating heat energy in an exothermic reaction in the form of a metal lattice supported hydrogen process, wherein the reaction vessel comprises:

a reaction chamber which is fillable with a reaction material for carrying out the exothermic reaction, and a heat transfer device for transferring heat into and/or out of the reaction chamber, wherein the heat transfer device comprises a tube system with several tubes for a heat transfer fluid which are lead into the reaction chamber and/or which pass through the reaction chamber.

Thus, the energy generating apparatus and in particular the control or control assembly thereof are designed such that the field generating device does not generate a reaction generating or maintaining field when the temperature in the reaction chamber is not above a predetermined critical temperature.

For the sole energy supply the control is connected to a thermoelectric generator for converting heat from the reaction chamber into electrical energy such that enough energy for generating the field is only available when the temperature is above a critical range, for instance 500° K.

Advantageously, the “critical temperature” is a temperature below which harmful radiations emerge or may emerge.

Advantageously the invention provides an energy generating apparatus for generating heat energy in an exothermic reaction in the form of an LENR by using a metal lattice supported hydrogen process, comprising:

a reaction vessel with a reaction chamber containing a reactive LENR material for carrying out the exothermic reaction, a field generating device for generating a field in the reaction chamber for activating and/or maintaining the exothermic reaction, a heat transfer device for transferring heat into and/or out of the reaction chamber. Advantageously, the energy generating apparatus further comprises: a operating parameter detecting device for detecting at least one operating parameter in the reaction chamber, and a control which is designed to control the field generating device and/or the heat transfer device depending on the detected operating parameter for stabilizing the exothermic reaction.

It is preferred that the operating parameter detecting device is designed to detect a temperature in the reaction chamber as operating parameter and/or is provided with a temperature sensor for detecting the temperature in the reaction chamber.

It is preferred that for the sole energy supply of the control a thermoelectric generator, which is designed to convert heat energy from the reaction chamber into electrical energy, is connected with the control, and/or that the control is operated by means of the heat from the reaction chamber.

It is preferred that the control is designed to control the electrical energy of the thermoelectric generator as the control parameter.

It is preferred that the field generating device is designed to generate an electromagnetic field for stimulating and maintaining the exothermic reaction, as for example an LENR, in the reaction chamber.

It is preferred that the control is designed such that the field generating device does not generate a field, which generates or maintains the reaction, when the temperature in the reaction chamber is not above a predetermined critical temperature or is not in a predetermined operating temperature range.

It is preferred that the reaction material is an LENR material or an LENR+ material which contains a fuel material with specifically formed micro- and/or nanoparticles for catalyzing an LENR+ process or for reacting in an LENR+ process and/or that the reaction chamber is dryly filled with LENR material containing nanoparticles and hydrogen.

It is preferred that the reaction material, in particular the LENR or LENR+ material, comprises micro- and/or nanoparticles of a metal, which is selected from a group which comprises transition metals of period 4 and below, for example Ni, Ti. These particles may be provided with other elements of the semimetals of group 5 and above or the transition metals of period 4 or below. Furthermore, a nano- or microstructure may be used which consists of transition metals of group 5 and above. As regards the production method which here is not interesting as such, surface promoting, defect promoting and cavity promoting methods are preferred. For more detailed information, reference is made to the citations [1] to [9].

It is preferred that the heat transfer device has a tube system for removing heat from the reaction chamber by means of a heat transport fluid.

It is preferred that the heat transfer device is designed to heat up the reaction chamber to an operating temperature for the nuclear process, as especially LENR process, by means of a heat transport fluid.

The heat transfer device is especially preferably used during a starting procedure for heating by means of the heat transport fluid and during operation for removing the heat.

It is preferred that a heat conducting casing encloses the reaction chamber.

It is preferred that the heat conducting casing encloses the reaction chamber and the tubes or conduits of the heat transfer device protruding into the reaction chamber or traversing the reaction chamber.

It is preferred that a thermoelectric layer attached to the reaction chamber is provided, in order to generate an electrical energy from the heat of the reaction chamber.

It is preferred that the thermoelectric layer is disposed at the casing or around the casing and that it is designed to generate electrical energy from heat when the exothermic reaction is in operation.

It is preferred that the control is energy supplied by the thermoelectric layer, in order to drive or control the field generating device for activating and/or maintaining the exothermic function upon reaching a predetermined operating temperature.

In particular, only at or above a certain temperature the thermoelectric layer supplies enough energy which enables the control to control or to drive the field generating device for activating and/or maintaining the exothermic function. If due to a lower temperature less energy is generated, accordingly the electric field is not generated.

It is preferred that conduits or tubes of the heat transport device are simultaneously designed as electrodes or poles of the field generating device.

According to a further aspect the invention provides an energy generating method for generating heat energy in an exothermic reaction in the form of a nuclear metal lattice supported hydrogen process comprising:

a) charging a reaction chamber with reaction material including micro- and/or nanoparticles for providing a metal lattice and hydrogen,
b) heating the reaction chamber to an operating temperature above a predetermined critical temperature,
c) producing a field for activating and maintaining the exothermic reaction by means of a field generating device which is controlled by a control depending on a temperature in the reaction vessel,
d) converting heat from the reaction chamber thermoelectrically into electrical energy in order to operate or supply the control directly and/or without energy buffering solely with this thermoelectrically converted electrical energy, and
e) discharging the excess heat generated by the exothermic reaction for the heat energy utilization.

Advantageously the invention provides an energy generating method for generating heat energy in an exothermic reaction in the form of an LENR by utilization of of a metal lattice supported hydrogen process comprising:

a) loading a reaction chamber with LENR material including micro- and/or nanoparticles for providing a metal lattice and hydrogen,
b) heating the reaction chamber to an operating temperature for LENR above a temperature which is critical for LENR,
c) generating a field for activating and maintaining the exothermic reaction by means of a field generating device, which is controlled by a control, depending on a temperature in the reaction chamber,
d) converting heat from the reaction chamber thermoelectrically into electrical energy in order to solely control or supply the control with this thermoelectrically converted electrical energy, and
e) discharging the excess heat generated by the exothermic reaction for a heat energy utilization.

Advantageously, the method furthermore comprises: driving the field generating device for generating the field only in the case in which an energy parameter, as in particular a voltage or a current strength, of the electrical energy delivered in step d) is above a predetermined threshold value, and terminating the field generation when the energy parameter is below a predetermined threshold value.

It is preferred that the field generating device or the control driving the field generating device is only then provided with sufficient energy for generating the field when the temperature in the reaction chamber is above the predetermined critical temperature.

The energy generating apparatus according to the invention and the energy generating method provide an apparatus and a method for generating energy according to the invention which are environmentally friendly and sustainable, which may be operated during a long time without recharging and which are moreover very compact. Furthermore, energy generating apparatuses are provided by the measures of the invention or its advantageous embodiment which may be operated reliably, safely and in a self-sustaining way. Accordingly, these systems may be operated in vehicles, and they are particularly suitable and intended for a use in the transportation sector. In particular, these systems may also be used in vehicles which provide an environment which is autarchic and subjected to vibrations.

In this apparatus and this method preferably LENR processes are used, which are fundamentally known. In particular, LENR materials are used as they are described in WO 2009/125444 A1, EP 2 368 252 B1 and WO 2013/076378 A2 in principle.

Advantageously, especially designed micro- and/or nanoparticles are used in the material. In an especially preferred embodiment the micro- and/or nanoparticles are specifically coated, especially with a poloxamer coating (PF68), as for example the coating which is described in [2]. In this document cavities are preferably produced by means of a method as it is described in [3].

In a preferred embodiment the energy generating apparatus comprises a container including a structure for a reactive material, a device for introducing an electromagnetic field, a mechanism for heat transfer and a control logic.

In a usable metal lattice supported process hydrogen is especially converted to helium gas, whereby a large amount of usable energy is released. The process takes place at an operating temperature, which is in contrast to the necessary temperatures for plasma fusion processes as they for instance take place in the sun—well manageable in industrially producible reactors. For this purpose, a suitable substrate of nickel or another metal which is suitable for this purpose with a correct internal geometry is used, wherein the hydrogen particles adhere in cavities in the metal lattice. A pulsed electromagnetic field or other corresponding fields—produce stress zones in the metal, and the used energy is concentrated within very small spaces.

For example, materials and reactions are employed as they are described in WO 2013/076378A2 and/or WO 2009/125444 A1. From [4] and [5] further materials with high-dense hydrogen in metal lattices may be gathered, which may be excited to exothermic reactions. These materials may be employed as well as reaction material.

WO 01/29844 A1 refers to “cold fusion”. In the literature, in connection with cold fusion a mechanism based on palladium and deuterium is proposed, wherein this mechanism is not sufficiently explained. Although the Ni—H mechanism is sometimes presented in some essays and is discussed under the term “cold fusion”, it is normally pointed to the fact that in the case of Ni—H different functional principles come into effect as compared with Pd-D. For a clear delimitation here the term “cold fusion” is linked to the originally used material function circle (Pa-D).

The explanation or implementation of the process prefers several levels or explanatory models, once the quantum condensate level, once the level of multi-bodyreactions. In other embodiments of the energy generating apparatus nuclear processes are employed which do not represent a classical “cold fusion” process. The here preferred methods are based in a first suitable type of processes, see for instance [4] and [5], on ultra-dense material (the above mentioned quantum condensate), which allows for a compression of hydrogen in the range of the Coulomb barrier also without additional heating of the active material. On the second level it may be said that due to catalytic reactions the reaction probability in multi-bodyprocesses may be considerably increased, also without needing the model of a quantum condensate. This type of processes is described in [6] and [7] (nuclear reaction probably increased by charged particle with electron host or charged particle host). The model levels between condensate and multi-body-process differ from each other very much as an explanation on wave level and an explanation on particle level, and at the same time they supplement each.

The first type of model processes is supported by a massive boson formation, which then permits a correspondingly sufficient particle density for a nuclear reaction. This differs from the familiar Fermionic material which satisfies Pauli's exclusion principle and which thus may not condense densely (like in the case of a boson condensate). Although in this connection the process is called fusion, it must further on be assumed that this does not represent a fusion in its classical sense. A fusion on electroweak level may also take place which exploits the spin order for reaching an energetically more bound state and for releasing energy thereby.

The reaction material and the process parameters are selected such that configurations are avoided in which harmful electromagnetic or baryonic radiation, as for example neutron radiations, are avoided. For this purpose, upon application of one of the teachings of the present invention the processes may be only started at temperatures at which such radiations are avoided or at least decreased. When such a safe temperature range is left (that is upon cooling down to too cold temperatures) the energy supply for generating the processes is automatically stopped, and thereby the processes are stopped.

The inventors assume that in such LENR processes the hydrogen nucleus, which in particular is a proton, is subjected to a nuclide-internal restructuring on the level of the weak and strong interaction. He4 may be a product thereof.

As it is also known for LENR processes resonance effects are used for enhancing the electromagnetic fields. Specific effects occur at 15 about THZ and 11 μm. The resonance effects are excited by a pulse slope which is initiated by an electromagnetic field via electrodes.

The pulse is generated by a control or control logic which is monitoring the status of the cell and the reaction chamber, respectively.

It is assumed that upon incorrect controlling or monitoring and controlling of the fields may lead to the generation of a dangerous radiation. A dangerous radiation may arise when there is no collective absorption of the electromagnetic radiation. This is especially the case when the reaction chamber is not at a suitable operating temperature. An operating temperature is a temperature above a temperature which is critical for such processes, like LENR processes. Typically, such operating temperature are in particular for Ni catalyzed processes at about 500 K or above. In processes utilizing carbon nanotubes typical operating temperatures are at about 1000 K. Depending on the material lower temperatures are as well conceivable which will be above the Debye temperature.

When a temperature below such a critical temperature or threshold temperature is reached in the reaction chamber, an undesirable radiation might occur. Such states might occur for example due to a modification by persons, an accidental situation or accidents or for example due to an accidental rise of the heat discharge during the operation. According to one aspect of the invention an energy supply for the control is designed such that the control is not supplied with sufficient voltage or sufficient energy and therefore no exothermic process is activated by trigger pulses when the reaction chamber is not at operating temperature and thus below a critical temperature. When the cell is at a sufficiently high temperature, the energy supply is sufficient, such that trigger pulses may be generated by pulse width modulation which activate the exothermic process.

Preferably the energy supply of the control is different from previous controls for such processes. The control is especially supplied with energy by means of the heat in the reaction chamber. The generated heat as such will be used by discharging the heat by means of the heat transport device. Thus, the control is provided by an own energy which is separated from the actual usable heat energy.

Preferably the heat transport device is used for heating the reaction chamber to the operating temperature. Only upon heating by means of this separate heat source, due to the energy supply of the control with the only then generated heat the reaction chamber will be supplied with sufficient energy for activating the LENR process. Accordingly, the operation of the reactor the energy supply for keeping up the temperature and the electrolysis and the control are supplied by different energy sources. Thus, a higher efficiency is obtained. Furthermore, the control is more stable in view of accidental performance drops, such that it may even work on due to its own energy supply, which is maintained by the reaction heat and may insofar continue to control the cell, when an external energy supply should malfunction due to an accident or incidentally.

Advantageous embodiments of the invention provide an apparatus and a method for generating energy which may be used in the transportation sector.

Especially preferred a solution is provided which meets all criteria 1 to 9 for such sources of exothermal energy as explained above.

Through the use of an exothermic reaction on the basis of an LENR or an LENR+ making use of hydrogen in a metal material at temperatures above a critical temperature and within a pulsed field so generating energy by converting captured hydrogen nuclei, an energy generating apparatus is provided which meets all features 1 to 7 of the advantageous criteria for energy sources for the transportation sector and which additionally also meets the features 8 and 9.

In an advantageous solution the energy generating apparatus has at least a cell or a reactor which comprises at least one, several or all of the following features i) to vii):

i) It contains a specifically designed nanoparticle-fuel-material, which catalyzes an LENR+ process or which reacts in an LENR+ process with hydrogen (the “+” designates the specifically designed nanomaterial).
ii) A tube system is provided which takes away the heat from the reaction product by means of a reaction fluid. In particular, a thermal fluid transportation tube system is provided.
iii) The reaction fluid is preferably used as well in order to heat the cell or the reactor chamber to the operating temperature. For LENR technology the operating temperature is approx. above 500 K.
iv) Further on a thermally conductive casing for encapsulating the tube and fuel system is provided.
v) A thermoelectric layer around the casing supplies electrical energy when the cell is in operation.
vi) An electrical compensation unit and a control are provided for controlling the operating mechanism such that the operation is stabilized.
vii) The control system is supplied with energy by the thermoelectric layer around the casing. The electric voltage of this thermoelectric layer is a monotonous function of the heat in the casing. When the cell is not at the operating temperature the electric voltage is smaller than a critical predetermined value, and the control does not supply the necessary pulses for the cell operation.

Heretofore, LENR cells have already been known, these, however, work with the risk of exothermic instable effects which may cause malfunction or which may lead to harmful explosions or to harmful radiations. Furthermore, pulsed systems are conceivable, which, however, are not self-sustaining, hence which are not autarchic. An energy impulse is used for heating the operating temperature for the reaction. At the operating temperature the exothermic process is initiated. This process is stable, but ceases after a period of time. Therefore, this second type of a known LENR process is stable, however, it is not self-sustaining or autarchic. It has a low efficiency as compared with autarchic systems and thus needs additional external energy and control.

However, with the preferred embodiment of the inventive apparatus and the inventive method a cell is provided which is autarchic and stable at the same time and which additionally is secure against manipulation in direction of an operation beyond the operating temperature.

In the preferred embodiment this is particularly achieved by means of the elements v) to vii) mentioned further above in more detail.

Until now it has been expected that LENR cells must have a vacuum in the internal mechanism or a wet operating environment. Due to the vacuum or the wet operating environment, however, strong internal mechanical impacts may occur which cause a burden due to mechanical loads which may occur under environment stress, as for example oscillations or vibrations. Due to this property of LENR cells designed until now the reliability during an operation in a transport means or in the transportation sector is deteriorated.

An advantageous embodiment of the invention, however, provides a dry environment—a dry reaction chamber, in which a pressure approximately at atmospheric level prevails.

Preferably, each cell nucleus unity is implemented in a very compact design. Hereby a high reliability may be expected, as only little internal stresses or loads occur under operating environments. A compact energy cell design already represents state of the art for other conventional energy conversion systems, however, the combination of an LENR cell with a compact load free or stress free mechanical design is not known.

Due to the properties of the autarchic and at the same time stable systems and the compact construction an LENR technology is designed for the first time such that it may also be employed in systems with pronounced mechanical vibrations as they may occur frequently in the transportation sector.

In the popular literature about LENR often also a so called “cold fusion” and the Pons-Fleischmann effect are mentioned. However, this Pons-Fleischmann effect only remotely deals with the here presented technology, especially as the physics behind the Pons-Fleischmann effect are only hardly understood. Nevertheless, the results of these experiments about Pons and Fleischmann are reproducible today, see the lectures and publications of Prof. Hagelstein of MIT and M. Swarts of JetEnergy with regard to the experiments FUSOR, NANOR. Furthermore, in France many references are indicated by Mr. Naudin. The experiments frequently relate to a wet cell and an operation with palladium, wherein a direct current or in special cases alternating current is used as well. Many first experiments about this effect remained at the detection limit.

In preferred embodiment of the here presented technology a dry cell is used, that is a reaction chamber with non-liquid filling. A gas mixture of hydrogen and/or potassium compound may eventually be employed. The energy for the excitation in these systems is supplied in a pulsed form. Thereby, specific system states—Rydberg atoms—may be excited. For a short moment the Rydberg atoms behave like a neutral nucleon. Thereby, a fusion with an electrically charged nucleus is possible. This principle is already put into practice by a number of companies—see Leonardo Corporation, Defkalion Green Technology, Brillouin Energy, Bolotov.

Thermoelectric layers for the utilization of expected reaction heat and for the conversion of the reaction heat into electrical energy have been proposed previously. However, in the preferred embodiment of the invention only the control and monitoring electronics are supplied with the electrical energy which is generated from heat by means of the thermoelectric conversion. The useful heat is lead out of the reaction chamber by means of the heat transfer unit—especially by means of a fluid

Concepts presented until now, in which the reaction heat for immediate production of electrical energy by means of thermoelectric layers is proposed, are judged as being rather infeasible. This may be determined from a very simple consideration of the efficiency.

An essential difference compared with earlier patent documents focusing on the fusion principles which utilize thermoelectric generators is that electrical energy correspondingly converted by thermogenerators in the embodiment of the invention is only employed for the energy supply—advantageously also for the exclusive energy supply—of a control and/or a monitoring electronics.

Examples for such earlier documents may be found in EP 0 724 269 A1, EP 0 563 381 A1, EP 0 477 018 A1, EP 1 345 238 A2 and EP 0 698 893 A2.

As a matter of course, thermoelectric generators are well known and it is known as well that such thermoelectric generators may be employed for generating electrical energy, as soon as heat is available.

However, in an especially preferred embodiment of the invention a thermoelectric generator is not employed for generating the useful energy, but a thermoelectric energy is used for the supply of the control of the reactor itself, wherein the delivered voltage may be considered as the control variable at the same time.

Thereby a more stable operation gets possible, on one hand in the start-up phase, as the energy from the process is directly used for the control. Thereby the cell is only activated when it is in the operating state. On the other hand a more stable operation becomes possible in the shut-off phase. If an external supporting energy source for the control and the energy to be inputted failed out, a cell whose control is supplied by the external energy would be in an undefined state. This is not the case for the solution proposed herewith, as the thermoelectric generator supplies the control auta with energy, as long as heat is available.

The separation of the control from the remaining power to be inputted here allows for a further control of the reactor, similarly as it would also be possible by creating a further redundancy. The residual energy from a heat storage and with this principle of “heat after death” is actually available and will also be available in case of an emergency. Thereby, a more stable system for a controlled shut-off is possible as if this was put into practice by means of an external power source.

Advantageously the energy generating apparatus is constructed modularly. Thereby, maintenance, stability and starting up are much more advantageous than in the case of known systems.

Advantageously the thermoelectric generator is not mounted in the reaction chamber itself but on the surface thereof. There much lower temperatures may be expected, which raise the expectation of a regular operation of semiconductor based thermoelectric generators.

Currently known thermocouples have an efficiency of about 10% even with the latest development. With the latest LENR+ technology the factors of supplied energy to delivered energy may be at 6 or above. Thus, uniquely based on efficiency calculations, the thermogenerators may not use the provided energy. However, the thermogenerators generate sufficient energy in order to supply the corresponding electronics with power for the control.

LENR and LENR+ may not be equated with “cold fusion”, but have further explanation principles which are based on Plasmon resonances; in particular, multi-body dynamics processes occur between catalyzing nucleons and reaction partners which suggest a contribution of weak interactions in the nuclear processes.

The LENR+ systems are preferably driven such that a controlled active environment is established, for example by a short-term heat supply, whereby the reaction is triggered or prepared. The process is activated and deactivated by a targeted pulse width modulation (PWM). It is expected that the edges of the pulse form in the high frequency region may stimulate resonances of the hydrogen system or of an artificial atom, for instance created by defects, and plasmons, and accordingly promote the reaction. Then the system is adjusted such that the process dies off by itself as soon as no further stimulation occurs.

The energy generating apparatus is advantageously a dry system which operates mechanisms which are based on thermogenerators for the control.

Generally, in earlier patent documents which refer to the Pons-Fleischmann effect hydrogen isotopes are mentioned, in order to include deuterium and tritium as well. Hydrogen isotope also includes the protium in other word the simple hydrogen. However, it is largely known that the devices working on the basis of the Pons Fleischmann principle may not be operated with normal hydrogen from water (protium).

However, in the preferred embodiment of the invention pure hydrogen obtained from water is used, that is with a natural isotope mixture and not with hydrogen having an increased nuclear number. This is much less expensive.

Summarizing for providing an environmentally friendly heat energy supply suitable for the transportation sector the invention establishes an energy generating apparatus for generating heat energy in an exothermic reaction in the form of a nuclear metal lattice supported hydrogen process, comprising:

A reaction vessel with a reaction chamber (16) containing a reaction material (45) for carrying out the exothermic reaction,

a field generating device (18) for generating a field in the reaction chamber (16) for activating and/or maintaining the exothermic reaction,
a heat transfer device (20) for transferring heat into and/or out of the reaction chamber (16), and a control (26) which is designed to control the field generating device (18) depending on the temperature in the reaction chamber for stabilizing the exothermic reaction, wherein the control (26) for the sole energy supply is connected with the thermoelectric generator for converting heat from the reaction chamber into electrical energy such that enough energy for generating the field is only available when the temperature is above a critical range, for example 500 K.

A system for heat generation by nuclear processes is proposed, which do not have to be fusion or fission processes. To that an apparatus is proposed, which however is oriented to stop the reaction or to modify the reaction correspondingly when the operating temperature may not be maintained and as a consequence harmful radiation from fusion or fission processes might occur. To that a control is provided.

The invention is based on the finding that such processes may also take place in the state of a cold apparatus, see [4], [5]. There, however, according to the findings of the inventors a harmful radiation may result, which is avoided by the invention. In contrast, the motivation in the prior art for a control by means of the operating temperature is directed to maintaining the operation and optimizing as regards the efficiency.

A preferred practical implementation of the apparatus uses a combination of a heat exchange technology or heat exchange construction and the corresponding control mechanism. Instructions for producing a reaction material may be found for instance in the U.S. Pat. No. 8,227,020 B1. With that each skilled person may produce a suitable reaction material.

A technology for generating heat is proposed, wherein reference is made to a design from a heat exchanger construction.

Furthermore, a control mechanism is proposed in order to guarantee the nonoperation at lower temperatures.

Embodiments of the invention are explained in more detail on the basis of the attached drawings. In the drawings

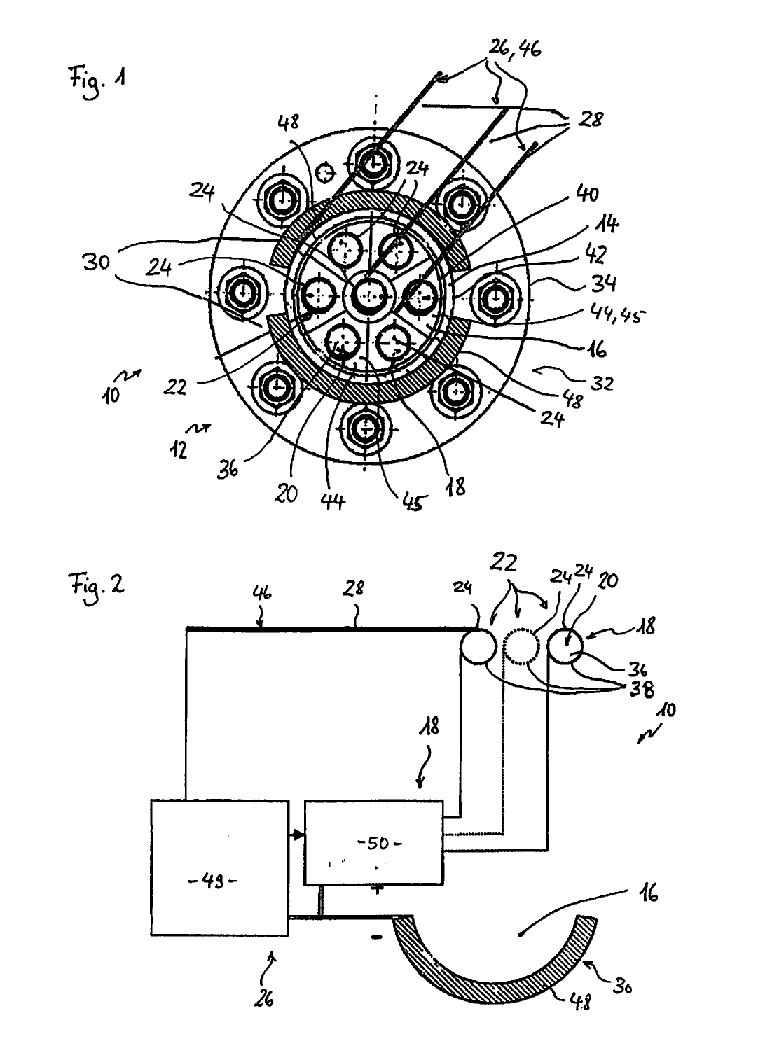

FIG. 1 shows a schematic representation of an energy generating apparatus with a cell for the energy generation, wherein the mechanical construction of the cell is shown in a partly cut representation;

FIG. 2 a block diagram of the electrical construction of the energy generating apparatus.

In the figures the mechanical and the electrical construction of an embodiment of an energy generating apparatus 10 comprising at least one cell 12 for the energy generation are shown.

The energy generating apparatus 12 is designed for the generation of heat energy by means of an exothermic reaction in the form of an LENR using a metal lattice supported hydrogen process. The cell 12 has at least one reaction vessel 14 which contains reactive LENR material.

Furthermore, a field generating device 18 is provided which generates a field in the reaction chamber 16 for activating and/or maintaining the LENR.

In particular, a field generating device 18 is designed to generate an electromagnetic field. Especially, a pulsed electromagnetic field may be generated therewith inside of the reaction chamber 16, in order to perform as is basically known an LENR reaction and more especially and LENR+ reaction.

Moreover, the cell 12 has a heat transfer device 20 for transferring heat into the reaction chamber 16 and for removing heat from the reaction chamber 16, respectively. The heat transfer device 20 has a tube system 22 with several tubes 24 guided into or passing through the reaction chamber 16.

Furthermore, the energy generating apparatus 10 comprises a control 26 which is designed to control the field generating device 18 for stabilizing the exothermic reaction. For this purpose at least one operating parameter is detected in or at the reaction chamber 16 by means of an operating parameter detecting device 28, wherein the control 26 is designed to perform the control of the cell 12 as a function of the detected operating parameter.

The operating parameter detecting device 28 is designed to detect a temperature in the reaction chamber 16 with regard to whether it is within a predetermined temperature range, which indicates an operating temperature for the LENR or LENR+. The operating temperature is above a predetermined critical temperature value for the LENR or LENR+ and is typically at or above approximately 500 K. The temperature range which indicates an operating temperature is that range in which an LENR or LENR+ proceeds without the emission of a harmful radiation and proceeds (exothermally) with the generation of heat.

For the sole energy supply of the control 26 a thermoelectric generator 30 is provided which converts heat energy from the reaction chamber 16 into electrical energy and which thereby supplies the control 26 with energy. A voltage supplied by the thermoelectric generator 30 may be used as a measure for the temperature in the reaction chamber 16. When the voltage is above a predetermined value it may be concluded that the temperature in the reaction chamber 16 is a predetermined operating temperature for the LENR or LENR+.

The control 26 and the thermoelectric generator 30 are designed such that the control 26 only controls or drives the field generating device 18 such that it generates the activating or maintaining field when the thermoelectric generator 30 supplies a voltage which indicates that the reaction chamber 16 is at operating temperature.

Thus, the supply unit 26, the thermoelectric generator 30 and the field generating device 18 form a control assembly making it possible to automatically avoid a stimulation at too low temperatures with the accompanying danger of harmful radiations.

In FIG. 1 only a single cell unit 32 of the cell 12 is represented. For a power of more than 100 W the energy generating device 10 may be formed by several smaller cell units 32. Advantageously at least five such cell units 32 are provided. Advantageously at least one of the cell units is permanently heated. In any case above 1 kW the construction made of several smaller cell units 32 should be selected.

In the following the structure of a single cell unit 32 will be described.

The structure of the cell 12 is based on a cylinder construction 34 which includes the reaction process and the electronic control logic the control 26. The cylinder construction contains tubes 24.

In one embodiment the tubes 24 are formed as copper tubes with a zirconium foam surface.

The tubes 24 serve for guiding a cooling fluid 36, and at the same time they serve as electrode 38 of the field generating device 18 for generating an electromagnetic field and for the electromagnetic stimulation.

The cylinder construction 34 has a sheath 40 enclosing the reaction chamber 16. The sheath 40 forms a part of a casing 42 enclosing the reaction chamber 16. Infrared-to-electricity converting foils 48 are arranged around the casing 42, which form part of the thermoelectric generators 30. Thus, the cell 12 is supported by the infrared-to-electricity converting foils 48 in order to create an autarchic operation.

The mechanical structure of the cell as illustrated above based on FIG. 1 is only given as an example.

The structure may adopt any other form which offers a suitable arrangement for establishing the reaction process. The reaction process is based on nano scaling and electromagnetic resonance including an interference pattern; therefore, a different macroscopic structure than the displayed structure is possible as well.

As an LENR material or an LENR+ material any reaction material causing an LENR process or an LENR+ process may be used. Such reactions are supported or assisted by a metal lattice. Hydrogen is bound to the metal lattice and subjected to an electromagnetic resonance. A high thermal energy may be produced, as is fundamentally known.

Additionally, a lattice of nickel in the form of a nano powder with a specific coating is proposed herewith as the metal lattice. The presented cell structure may be operated with a nickel alloy hydrogen system, however, a palladium deuterium system will function as well when a coating is adjusted. Furthermore, it is known that other lattices provide suitable reactions for H or D, as for example titanium or tungsten.

The cell 12 needs one and only one hydrogen loading process before operation. During the loading the hydrogen is ionized and enters the metal lattice in the form of hydronium. After the loading the operation of the cell may take place continuously during several months.

The main reaction is provided by the known LENR process. In order to obtain this process, the reaction must be stimulated. The application of a high voltage between the individual tubes 24 and the outer casing 42 generates a high electromagnetic field strength and causes local discharges. This is carried out by means of a pulse width modulation.

The tubes 24 are embedded within a foam 44 which contains especially designed particles—nanoparticles—made of nickel and further constituents—coating of PF68, which is produced as described in [2], and zirconium. This foam with nanoparticles constitutes the LENR material 45, which is filled into the reaction chamber 16.

In the so designed nanoparticles cavities are formed by a process known from [3].

The discharge stimulates the hydrogen nuclei which have entered sites of the foam cavities.

The sites of the hydrogen nuclei are subjected to a high electromagnetic voltage or electromagnetic load in this configuration and may pass through different exothermic reaction channels, as is described by the LENR technology, which in turn will be described in the following:

Due to the transition character of the discharge all frequencies which may stimulate hydrogen in the lattice close to the cavity are obtained. Especially the own frequencies below the lowest orbitals (sub-low orbit own frequencies) are responsible for the combination of two hydrogen nuclei and the exothermic process. These own frequencies are furthermore based on the Stefan-Boltzmann's law for the radiation of a black body, wherein the Gamow frequency is in optical resonance with the particle size. In order to obtain this goal a foam cavity size of 7 nm should be generated during the foam generating method, however, different cavity sizes may work as well. A deuterium nucleus is the result of the reaction, which arises from an electromagnetically coupled state of the two hydrogen protons close to the wall of the coated nickel nanopowder. Further processes towards He4 occur in the presence of zirconium. An EM stimulation produces EM surface waves at the nano powder particles. Along the wall boundary layer the hydronium adheres by means of chemical bonding forces. At the voids in the lattice matrix, which are produced by the foam process substances, electrons of a hydrogen pair couple with voids in the lattice and generate quasi atoms (quantum dots). At this dot or point the hydronium is polarized and may couple with the neighborhydronium to form a kind of a “quasi-deuterium”. This binding state has a lower energy than for the unloaded lattice and the free hydrogen. This energy is transferred to the lattice by a mechanical multi body process. The multi body process is based on electromagnetic (EM) forces and phonon transfer.

FIG. 1 shows a mechanical draft of the cell 12 and the cooling flow tubes. Several tubes are implemented. The tubes 24 are enveloped by an adapted specific macroscopic form of a foam in order to fit as a closed section into the cylinder construction 34. Depending on at which different tubes 24 a voltage is applied, different discharge sections may be activated.

In FIG. 1 the control 26 is suggested by connectors of a thermocoupling 46. The energy generating apparatus 10 and its cell 12 are temperature controlled—thermocoupling—and the performance requirement is inherently defined by the external heat requirement—flow rate or flow velocity, flow capacity. The request of a higher thermal loading is indicated and controlled by a lower temperature at a place of a cooling fluid flow source at the tube system 22—especially at an inlet of at least one tube 24.

Due to this reason the construction may be designed independent of the pump system. A pump system—not presented—is assumed as an external unit. Thereby a maximum number of applications may be created with one and the same construction.

Each tube, which for example is manufactured of copper, is electrically isolated.

In the following the electrical construction is explained in more detail referring to FIG. 2.

FIG. 2 shows a block diagram of an embodiment of the electrical construction. Tubes 24 formed of an electrically conductive material—as for example copper—are indicated by circles, the thermoelectric generator 30 with the infrared-to-electricity foils 48 by the form which is also used in FIG. 1.

The infrared-to-electricity-converter foil 48 solely supplies the digital control logic 49 forming the control 26 and a unity 50 for the pulse width modulation and for a voltage conversion with energy. The thermocoupling 46 forms a temperature sensor for the operating parameter detecting device 28 for detecting a temperature as operating temperature.

The energy generating apparatus 10 and its cell 12 may be provided for a power in the range from some Watts up to the Megawatt region depending on the pulse width modulation for the process and a heat exchange.

In view of its construction the heat transfer device 20 with heat exchangers is depending on the external consumers which shall be provided with power. According to their requirements the diameter of the tubes 24 and the flow rate are determined. The construction and its sizing—dimensioning—may be obtained on the basis of usual rules for the construction of heat exchangers by scaling.

FIGS. 1 and 2 show the foil like thermoelectric converters—thermoelectric generator 30—in the form of infrared-to-electricity-foils 48, which convert about 5% energy which has been converted from the process energy, into electrical energy. The technical sizing of the heat flow is made such that 5% are absorbed in the infrared-to-electricity-foil 48. The remaining part is absorbed in the cooling fluid 36.

When the cooling fluid 36 does not supply thermal power, the no load temperature of the cooling fluid is maintained, and superfluous heat is removed via the casing 42.

During the operation in the air or the atmosphere additional fins or surface enlargement devices may be provided at the casing 42 for removing heat via heat radiation and convection which is produced in the idle or no load state without heat power of the cooling fluid. During operation in a vacuum the surface of the casing 42 is enlarged by the fins to an extent that the complete heat is discharged by thermal radiation, or an (additional) heat tube system (not shown) is installed, when a larger heat quantity has to be removed from the wall of the casing 42.

In the following it will be illustrated how the cell 12 has to be prepared before an operation.

After having been loaded with the LENR material, the reaction vessel 14—formed by the casing 42—is evacuated with a vacuum pump over an extended period of time—for instance during two weeks or more. This process may be optimized by appropriate measures, e. g. by pulsing or heating during the loading. Accordingly, the term “vacuum pump” includes all mechanisms available for evacuating, also advanced methods for evacuating being included, as for examples radio frequency signals, which are transmitted through the cell 12 during the loading process. After—depending on the evacuation technology—the reaction chamber 16 has been evacuated to a suitable pressure, the reaction chamber 16—that is the reaction vessel 14, formed up by the casing 42—and thus the inner part of the cylinder construction 34 containing the LENR material is loaded with hydrogen. In particular, hydrogen is loaded into the cylinder construction 34 up to ambient pressure. A measurement of the loading may be carried out with the digital control logic—control 26. For example a measurement of the loading may be carried out by measuring the resistance between the tubes 24. A higher hydrogen load reduces the electrical resistance. For this purpose the resistance measurement is calibrated or verified before operation.

In order to start the process, the reaction chamber 16 is brought to the operating temperature by means of heated cooling fluid; via the thermoelectric generator 30 the heat supplies electrical energy for the control 26 which starts the EM field and the discharge by means of PWM, thereby activating the LENR+.

In other embodiments other reaction materials may be used as they may be taken or derived from [4] or [5] or [6] to [9].

For the implementation with new reaction materials first of all the critical temperature is identified by means of experiments below which during the reaction—in particular LENR or LENR+—radiation (for example neutron radiation) may be caused which has to be avoided. The thermoelectric generator 30 and the control 26, respectively, are then adjusted or designed such that only above this critical temperature sufficient energy is available for the generation of the field which initiates or maintains the reaction.

### LISTING OF REFERENCE NUMERALS

10 energy generating apparatus
12 cell
14 reaction vessel
16 reaction chamber
18 field generating device
20 heat transfer device
22 tube system
24 tube
26 control
28 operating parameter detecting device
30 thermoelectric generator
32 cell unit
34 cylinder construction
36 cooling fluid
38 electrode
40 sheath
42 casing
44 foam
45 LENR material
46 thermocoupling
48 infrared-to-electricity-foil
49 digital control logic
50 unit for PWM and voltage conversion
52 temperature sensor

1. An energy generating apparatus for generating heat energy in an exothermic reaction in the form of a metal lattice supported hydrogen process, comprising:
a reaction vessel having a reaction chamber configured to contain reaction material to perform the exothermic reaction;
a field generator configured to generate a field in the reaction chamber to activate and/or maintain the exothermic reaction;
a heat transfer device configured to transfer heat into and/or out of the reaction chamber;
a control configured to control the field generator depending on a temperature in the reaction chamber to stabilize the exothermic reaction; and
a thermoelectric generator configured to convert heat from the reaction chamber into electrical energy, the thermoelectric generator being connected with the control as a sole energy supply of the control, to operate the control by heat of the reaction chamber such that the control is supplied with sufficient energy, when the temperature in the reaction chamber is above a predetermined critical temperature, in order to control the field generator to generate the field which activates and/or maintains the exothermic reaction.

2. The energy generating apparatus according to claim 1, further comprising
an operating parameter detector configured to detect at least one operating parameter in the reaction chamber, such that the control operates to control the heat transfer device depending on the

3. The energy generating apparatus according to claim 2, wherein at least one of the following
the operating parameter detector is configured to detect the temperature in the reaction chamber as the operating parameter; and
the operating parameter detector includes a temperature sensor configured to detect the temperature in the reaction chamber.

4. An energy generating apparatus according to claim 3, wherein
the control is configured to control the electrical energy of the thermoelectric generator as the control parameter.

5. The energy generating apparatus according to claim 1, wherein
the field generator is configured to generate the field as an electromagnetic field to activate and/or maintain the exothermic reaction in the reaction chamber.

6. The energy generating apparatus according to claim 1, wherein
the energy generator is configured to generate heat in a low-energy nuclear reaction (LENR) in the form of a metal lattice supported hydrogen processes in which the reaction material is an LENR material.

7. The energy generating apparatus according to claim 6, wherein the reaction chamber is dryly filled with LENR material containing microparticles and/or nanoparticles, and hydrogen.

8. The energy generating apparatus according to claim 1, wherein
the reaction material comprises microparticles and/or nanoparticles of a metal, which is selected from a group which comprises Ni, Pd, Ti and W, and the microparticles and/or nanoparticles include a polymer coating or a poloxamer coating and cavities which are produced by radiation or an ion track method.

9. The energy generating apparatus according to claim 1, wherein
the heat transfer device comprises a tube system configured to remove heat from the reaction chamber by a heat transport fluid, and the heat transfer device is configured to heat up the reaction chamber to an operating temperature for the exothermic reaction by the heat transport fluid;
the reaction chamber is included in a heat conducting casing and tubes of the tube system protrude into the reaction chamber;
a thermoelectric layer is provided at the casing or around the casing and is configured to generate electrical energy from heat when the exothermic reaction is in operation; and
the control is energy supplied by the thermoelectric layer, in order to control the field generator to activate and/or maintain the exothermic function when a predetermined operating temperature is reached.

10. The energy generating apparatus according to claim 9, wherein the tubes of the heat transport device are configured as electrodes or poles of the field generator.

11. The energy generating apparatus according to claim 1, wherein
the predetermined critical temperature is in the range from 500° K to 1000° K.

12. A control assembly for an energy generating apparatus according to claim 1.

13. A reaction vessel for an energy generating apparatus for generating heat energy in an exothermic reaction in the form of a metal lattice supported hydrogen process, the reaction vessel comprising:
a reaction chamber configured to contain a reaction material to perform an exothermic reaction;
the thermoelectric generator configured to convert heat from the reaction chamber into electrical energy for the energy supply of a control; and
a heat transfer device comprising a tube system including several tubes that are configured to provide a heat transfer fluid, the tubes being lead into the reaction chamber and/or passing through the reaction chamber.

14. The reaction vessel according to claim 13, wherein
the heat transfer device is configured to heat up the reaction chamber to an operating temperature for the exothermic reaction by the heat transport fluid.

15. The reaction vessel according to claim 13, wherein
the reaction chamber is enclosed in a heat conducting casing and the tubes of the tube system protrude therein.

16. (canceled)

17. The reaction vessel according to claim 13, wherein
at least some of the tubes of the heat transfer system are provided with a thermoelectric layer.

18. The reaction vessel according to claim 15, further comprising
a thermoelectric layer disposed at the casing or around the casing and configured to generate electrical energy from heat from the reaction chamber.

19. The reaction vessel according to claim 13, further comprising
a cylinder construction comprising a cylinder sheath wall enclosing the reaction chamber.

20. The reaction vessel according to claim 19, wherein
the tubes are guided through the reaction chamber in parallel with the middle axis of the cylinder construction.

21. The reaction vessel according to claim 13, wherein
the tubes of the heat transfer device are configured as electrodes or poles of a field generating device configured to generate a field that activates and/or maintains the exothermic reaction.

22. An energy generating method for generating heat energy in an exothermic reaction in the form of a metal lattice supported hydrogen process the energy generating method comprising:
loading a reaction chamber with reaction material including microparticles and/or nanoparticles to provide, a metal lattice and hydrogen;
heating the reaction chamber to an operating temperature above a predetermined critical temperature;
generating a field to activate and/or maintain the exothermic reaction by a field generator, which is controlled by a control, depending on a temperature in the reaction chamber;
converting heat from the reaction chamber thermoelectrically into electrical energy in order to solely operate or supply the control directly and/or without energy buffering with this thermoelectrically converted electrical energy; and
discharging the excess heat generated by the exothermic reaction for a heat energy utilization.

23. The energy generating method according to claim 22, wherein the generating and converting include:
driving the field generator to generate the field when an energy parameter of the electrical energy delivered during the converting is above a predetermined threshold value, and terminating the field generation when the energy parameter is below the predetermined threshold value.

24. The energy generating method according to claim 23, wherein
the field generator or the control that drives the field generating device is supplied with sufficient energy to generate the field when the temperature in the reaction chamber is above the predetermined critical temperature.

25. (canceled)
